(19) United States
(12) Patent Application Publication
(10) Pub. No.: US 2026/0277129 A1
(43) Pub. Date: Sep. 17, 2026

(54) IMAGE FORMING APPARATUS THAT PRINTS IMAGE BY ELECTROPHOTOGRAPHY

(71) Applicant: KYOCERA Document Solutions Inc., Osaka (JP)

(72) Inventors: Kenshin MATSUUCHI, Osaka (JP); Jun NAKAI, Osaka (JP)

(73) Assignee: KYOCERA Document Solutions Inc., Osaka (JP)

(21) Appl. No.: 19/555,139

(22) Filed: Mar. 3, 2026

(30) Foreign Application Priority Data
Mar. 11, 2025 (JP) 2025-038707

(51) Int. Cl. G03G 15/043; G03G 15/00; G03G 15/04

(52) U.S. Cl. CPC G03G 15/043; G03G 15/04072; G03G 15/0409; G03G 15/5062; G03G 2215/00067; G03G 2215/0404

(57) ABSTRACT

A controller causes laser diodes adjacent to each other to form detection patches on a sheet, each including a plurality dot patterns of a same shape, arranged in a main scanning direction and a sub scanning direction at predetermined intervals, with respect to each of the dot patterns, acquires the density of the detection patches, among which the dot pattern is different, from a density detection device, calculates a beam pitch shift amount using the density of each of the detection patches, and adjusts light emission timing of the light beam emitted from a laser diode, using the beam pitch shift amount calculated. A light amount of the light beam emitted from the laser diode to form the dot pattern is set to a predetermined light amount for adjustment, smaller than a normal light amount to form a normal electrostatic latent image.

### INCORPORATION BY REFERENCE

This application claims priority to Japanese Patent Application No.2025-038707 filed on Mar. 11, 2025, the entire contents of which are incorporated by reference herein.

### BACKGROUND

The present disclosure relates to an image forming apparatus that prints an image by electrophotography.

An electrophotographic image forming apparatus is known that employs a multibeam system, to scan a photoconductor drum with light beam from a light source unit having a plurality of laser diodes, thereby forming an electrostatic latent image.

When a plurality of light beams scan the photoconductor drum, the pitch between the laser diodes has to be adjusted according to writing resolution. Normally, the beam pitch along the sub scanning direction is adjusted by the rotation of the light source unit, and the beam pitch along the main scanning direction is adjusted by the light emission timing. With such arrangement, an image free from a positional shift can be formed on the surface of the photoconductor drum.

The beam pitch of the laser diode along the main scanning direction is measured on the production line of the optical scanning device, and the measured value is stored in a memory provided in the optical scanning device. The image forming apparatus retrieves the measured value from the memory of the optical scanning device, when performing the printing operation, and adjusts the light emission timing of the laser diode.

The value of the beam pitch measured on the production line of the image forming apparatus, and the actual beam pitch may discord from each other. This is because of, for example, nonuniformity in the assembly work of the image forming apparatus, a positional shift of the optical scanning device installed in the main body of the image forming apparatus, and a processing allowance of optical parts located between the light source unit and the photoconductor drum. The discordance of the beam pitch arising from the mentioned reasons may lead to degradation in picture quality.

A method of measuring the beam pitch between the laser diodes, and adjusting the light emission timing has been proposed. More specifically, the method includes drawing six types of specific image patterns and measuring the image density, and measuring a beam pitch shift amount on the basis of the image density, utilizing a correlation between the beam pitch shift amount and the density difference of the pattern.

### SUMMARY

The disclosure proposes further improvement of the foregoing technique.

In an aspect, the disclosure provides an image forming apparatus including an image forming device, a density detection device, a storage device, and a control device. The image forming device includes an optical scanning device that forms, using a light source having a plurality of light emitters, aligned at regular intervals at a predetermined angle with respect to a main scanning direction, and a polygon mirror that deflectively scans a light beam emitted from each of the light emitters, an electrostatic latent image on an image carrier with the light beam, and prints an image on a sheet, by transferring a toner image obtained by developing the electrostatic latent image, onto the sheet. The density detection device detects image density of the image printed on the sheet. The storage device stores therein a predetermined plurality of types of dot patterns, for calculating a beam pitch shift amount, which is a shift amount of a pitch between the light beams in the main scanning direction, and formed on the image carrier by the light beam emitted from an adjacent light emitter. The control device includes a processor, and acts as a controller when the processor executes a control program. The controller causes the image forming device to form detection patches, each including a plurality of the dot patterns of a same shape, arranged in the main scanning direction and a sub scanning direction at predetermined intervals, with respect to each of the dot patterns, and to print the detection patches on the sheet, acquires density of the detection patches, among which the dot pattern is different, from the density detection device, calculates the beam pitch shift amount using the density of each of the detection patches, and controls the optical scanning device to adjust light emission timing of the light beam emitted from the light emitter, using the beam pitch shift amount calculated. The controller sets, when the image forming device forms the detection patch, a light amount of the light beam emitted from the light emitter to a predetermined light amount for adjustment, smaller than a predetermined normal light amount of the light beam, emitted to form a normal electrostatic latent image, and which secures detection accuracy of the beam pitch shift amount, equal to or higher than a predetermined threshold.

### BRIEF DESCRIPTION OF THE DRAWINGS

FIG. 1 is a front cross-sectional view showing a structure of an image forming apparatus;

FIG. 2 is a perspective view for explaining an optical scanning operation, performed by an optical scanning device;

FIG. 3 is a perspective view showing a light source unit;

FIG. 4 is a block diagram showing an electrical configuration of the image forming apparatus;

FIG. 5 is a schematic diagram for explaining the start of dots;

FIG. 6 is a schematic diagram for explaining the start of the dots;

FIG. 7 is a schematic diagram showing an example of a detection pattern according to a first embodiment;

FIG. 8 is a schematic diagram showing another example of the detection pattern according to the first embodiment;

FIG. 9 is a schematic diagram for explaining a detection patch;

FIG. 10 is a schematic diagram for explaining the detection patch;

FIG. 11 is a schematic diagram for explaining the detection patch;

FIG. 12 is a schematic diagram for explaining the detection patch;

FIG. 13 is a schematic diagram for explaining the detection patch;

FIG. 14 is a schematic diagram for explaining the detection patch;

FIG. 15 is a schematic diagram collectively showing dot patterns;

FIG. 16 is a graph showing a relation between a specified shift amount and a density difference of a detection pattern;

FIG. 17 is a schematic drawing showing an example of the detection pattern, drawn when a beam spot position is shifted to the downstream side in the main scanning direction;

FIG. 18 is a schematic diagram for explaining the detection patch;

FIG. 19 is a schematic diagram for explaining the detection patch;

FIG. 20 is a schematic diagram for explaining the detection patch;

FIG. 21 is a schematic diagram for explaining the detection patch;

FIG. 22 is a schematic diagram for explaining the detection patch;

FIG. 23 is a schematic diagram for explaining the detection patch;

FIG. 24 is a schematic diagram collectively showing dot patterns;

FIG. 25 is a graph showing a relation between the specified shift amount and the density difference of the detection pattern;

FIG. 26 is another graph showing a relation between the specified shift amount and the density difference of the detection pattern;

FIG. 27 is a graph showing a relation between a light amount of a laser diode and detection sensitivity of a beam pitch shift amount, when drawing the detection pattern;

FIG. 28 is a schematic drawing showing an example of the detection pattern, according to a second embodiment; and

FIG. 29 is a schematic diagram for explaining the beam pitch of the light beam emitted from the laser diode.

### DETAILED DESCRIPTION

### First Embodiment

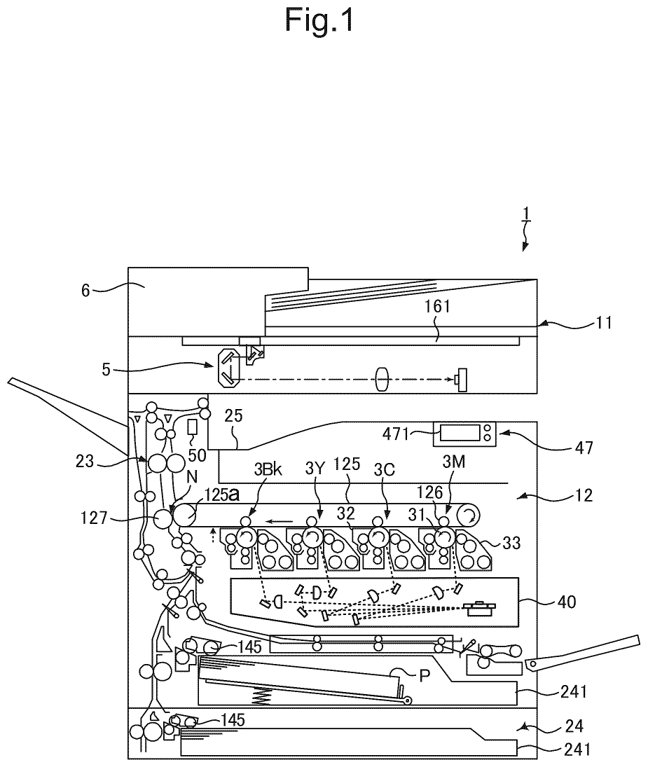

Hereafter, an image forming apparatus according to the disclosure will be described, with reference to the drawings. FIG. 1 is a front cross-sectional view showing a structure of the image forming apparatus 1 according to a first embodiment of the disclosure. The image forming apparatus 1 according to the first embodiment of the disclosure may be a multifunction peripheral having a plurality of functions, such as copying, printing, scanning, and facsimile transmission, or an image forming apparatus such as a copier, a printer, or a facsimile machine. Although a color image forming apparatus will be referred to in this embodiment, the disclosure is also applicable to an image forming apparatus for monochrome printing.

The image forming apparatus 1 includes an input device 47, an image forming device 12, a fixing device 23, a sheet feeding device 24, a document feeding device 6, and an image reading device 5, which are accommodated in a main body 11.

When the image forming apparatus 1 performs a document reading operation, the image reading device 5 optically reads the image of a document, delivered from the document feeding device 6 or placed on a platen glass 161, and generates image data. The image data generated by the image reading device 5 is stored, for example, in a built-in HDD, or a computer connected via a network.

When the image forming apparatus 1 performs an image forming operation, the image forming device 12 forms a toner image on a sheet P, delivered from the sheet feeding device 24, on the basis of the image data generated through the document reading operation. In the case of color printing, an image forming unit 3M for magenta, an image forming unit 3C for cyan, an image forming unit 3Y for yellow, and an image forming unit 3Bk for black of the image forming device 12 each form the toner image on a photoconductor drum 31 (image carrier) through charging, exposing, and developing processes, on the basis of the image of the respective color components constituting the image data, and the toner image is transferred onto an intermediate transfer belt 125, via a primary transfer roller 126.

The image forming units 3M, 3C, 3Y, and 3Bk each includes a non-illustrated toner cartridge of the corresponding color. The toner cartridge accommodates therein the toner, which is a consumable to be consumed by the image forming operation on the sheet, performed by the image forming device 12. The toner cartridge is removably mounted on the image forming unit 3M, 3C, 3Y, or 3Bk, and when the toner cartridge becomes empty, the user replaces the toner cartridge with a new one.

The toner images of the respective colors, transferred to the intermediate transfer belt 125 as primary transfer, are overlaid on each other at an adjusted timing on the intermediate transfer belt 125, and formed into a colored toner image. A secondary transfer roller 125a transfers the colored toner image formed on the surface of the intermediate transfer belt 125, to the sheet P transported from the sheet feeding device 24 along the sheet transport route, at a nip region N where the intermediate transfer belt 125 is pinched between the secondary transfer roller 125a and a drive roller 127. Then the fixing device 23 fixes the toner image onto the sheet P, by thermal compression, and the sheet P is delivered to an output tray 25.

The sheet feeding device 24 includes a plurality of sheet cassettes 241. The sheet cassettes 241 each accommodate therein the sheet P to be transported to the image forming device 12. A controller 91, to be subsequently described, drives a pickup roller 145 of the sheet cassette 241 to rotate, thereby transporting the sheet P in the corresponding sheet cassette 241 toward the image forming device 12.

The image forming units 3M, 3C, 3Y, and 3Bk will be described hereunder. Around the photoconductor drum 31, which is rotatably installed, a charging device 32 that electrically charges the photoconductor drum 31, an optical scanning device 40 that exposes the photoconductor drum 31 to image information based on the image data, a developing device 33 that forms the toner image on the photoconductor drum 31, and a cleaning device that removes the toner remaining on the photoconductor drum 31, are provided.

In each of the image forming units 3M, 3C, 3Y, and 3Bk, the surface of the photoconductor drum 31 is uniformly charged, and scanned by the light beam emitted from the optical scanning device 40, so that an electrostatic latent image is formed. Then the electrostatic latent image is developed by the toner into the toner image, and the toner image formed on the surface of the photoconductor drum 31 is transferred to the intermediate transfer belt 125. The image forming units 3M, 3C, 3Y, and 3Bk each transfer the toner image of the corresponding color on the intermediate transfer belt 125, by overlaying the toner images on each other, thereby forming the colored toner image.

A density sensor 50 (density detection device), which detects the density of the image printed on the sheet P, is located on the sheet transport route, at a position between the fixing device 23 and the delivery port to the output tray 25.

The density sensor 50 includes, for example, a light emitting element that emits light, and a photodetector that receives the light emitted from the light emitting element and reflected. The density sensor 50 emits the light to the printed face of the sheet, which has undergone the fixing process, and detects the light reflected by the sheet, thereby measuring the optical density of the printed image (detection pattern to be subsequently described). The density sensor 50 converts the measurement result to an electrical signal, and outputs the electrical signal to the controller 91. Here, it suffices that the density sensor 50 is capable of detecting the image printed on the sheet P, and may have a structure other than the combination of the light emitting element and the photodetector.

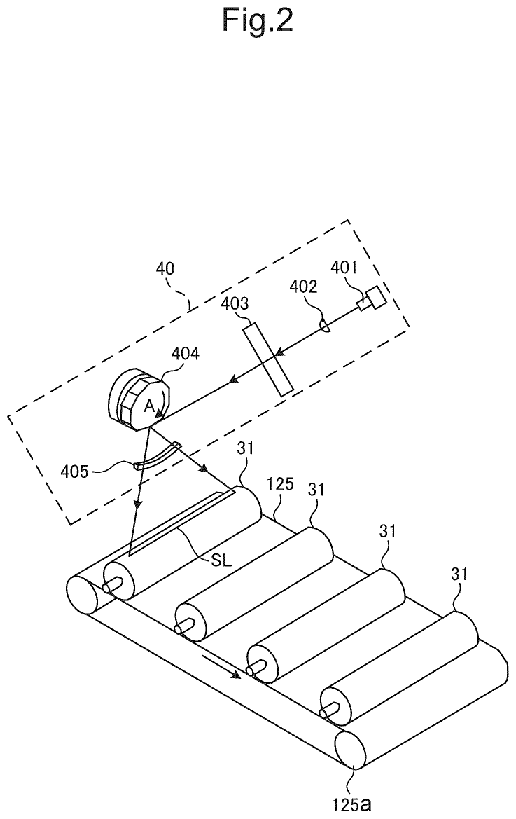

FIG. 2 is a perspective view for explaining the optical scanning operation, performed by the optical scanning device 40. Here, although the optical scanning device 40 scans the respective photoconductor drums 31 of the image forming units 3M, 3C, 3Y, and 3Bk, the scanning on one of the photoconductor drums 31 will be described, for the sake of simplicity.

The optical scanning device 40 includes a light source unit 401 (light source), a collimator lens 402, a cylindrical lens 403, a polygon mirror 404, and an fθ lens 405.

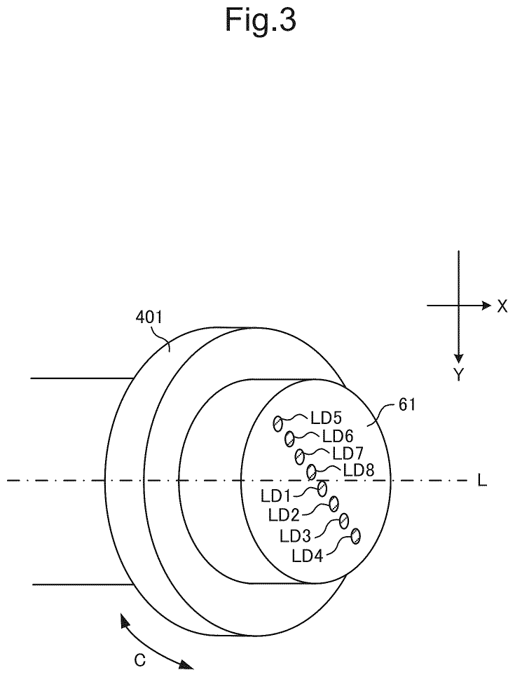

FIG. 3 is a perspective view showing the light source unit 401. The light source unit 401 includes eight laser diodes LD1 to LD8 (light emitter) provided on a front end face 61. The laser diodes LD1 to LD8 are linearly aligned at regular intervals along the radial direction of the light source unit 401, and fixed, with the interval between the laser diodes LD1 to LD8 in the sub scanning direction adjusted, by rotating the light source unit 401 about an axial line L passing the center of the front end face 61 (as indicated by an arrow C). Hereinafter, the laser diodes LD1 to LD8 will be collectively referred to as “laser diode LD”.

Referring again to FIG. 2, the collimator lens 402 converts the light beam emitted from the light source unit 401 into a generally parallel light flux. The cylindrical lens 403 possesses a predetermined refractive force, only in the sub scanning direction of the light beam. The light source unit 401, the collimator lens 402, and the cylindrical lens 403 are linearly located.

The polygon mirror 404 has a regular polygonal column shape, having a deflection facet formed on each lateral face. The deflection facet has a mirror surface, to deflectively reflect the light beam emitted from the light source unit 401. The polygon mirror 404 is made to rotate, by a non-illustrated polygon motor, in a direction indicated by an arrow A.

The fθ lens 405 possesses fθ characteristics. The fθ lens 405 is located between the polygon mirror 404 and the photoconductor drum 31. The light beam emitted from the light source unit 401 is sequentially incident on the collimator lens 402 and the cylindrical lens 403, and forms an image on the deflection facet of the polygon mirror 404. The light beam forming the image on the deflection facet is deflected and passes through the fθ lens 405, and then forms the image on the surface of the photoconductor drum 31.

The polygon mirror 404 is made to rotate by the polygon motor, at a uniform speed in the direction of the arrow A. Accordingly, the light beam scans the surface of the photoconductor drum 31, at a uniform speed in the main scanning direction (arrow X) parallel to the rotation axis of the photoconductor drum 31. As result, a scanning line SL is formed on the surface of the photoconductor drum 31. One scanning line SL is drawn by one deflection facet. As the photoconductor drum 31 rotates, a plurality of scanning lines are formed thereon in the sub scanning direction, so that an electrostatic latent image is formed on the surface of the photoconductor drum 31.

The beam pitch of the laser diode LD in the main scanning direction is measured on the production line of the optical scanning device 40, and the measured value is stored in a memory 41 provided in the optical scanning device 40. When performing the printing operation, the controller 91 retrieves the measured value from the memory 41, and adjusts the light emission timing of the laser diode LD.

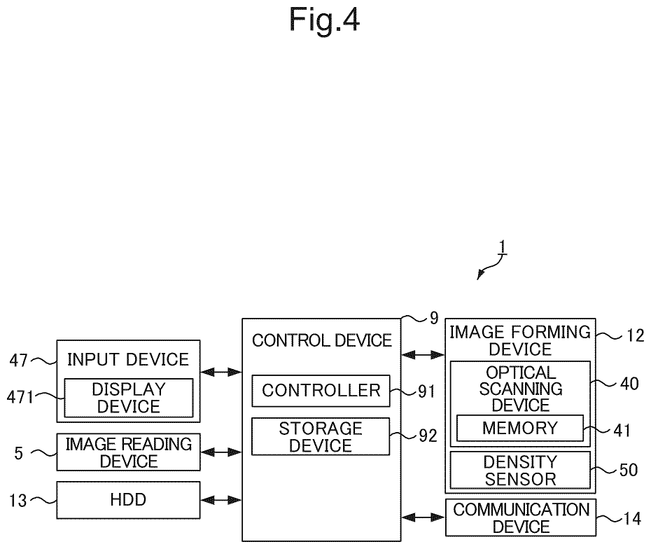

FIG. 4 illustrates an electrical configuration of the image forming apparatus 1. The same components as those explained in FIG. 1 are given the same reference numerals, and explanations thereof will be omitted in FIG. 4. The image forming apparatus 1 includes a control device 9, an input device 47, the image reading device 5, the image forming device 12, an HDD 13 and a communication device 14.

The input device 47 includes hard keys such as an enter key and a start key for inputting various operations and settings, and a display device 471. The display device 471, which displays operation screens and messages, may be integrally constituted with a touch panel.

The HDD 13 is a memory unit containing various types of image data, programs, and data tables. The communication device 14 includes a communication module, and transmits and receives various types of data, to and from an external device via the network.

The control device 9 includes a processor, a random-access memory (RAM), and a read-only memory (ROM). The processor is, for example, a central processing unit (CPU), an application specific integrated circuit (ASIC), or a micro processing unit (MPU). The control device 9 acts as the controller 91 and a storage device 92, when the processor operates according to a control program stored in the ROM. Here, the controller 91 and the storage device 92 may each be constituted in the form of a hardware circuit, instead of being realized by the operation according to the control program.

The controller 91 serves to control the overall operation of the image forming apparatus 1. The controller 91 also causes two laser diodes LD adjacent to each other to form a detection patch, to be subsequently described, and prints the detection patch on the sheet P, and then acquires the image density of the detection patch, from the density sensor 50. Further, the controller 91 calculates the beam pitch shift amount between the laser diodes, using the density of the detection patch, and adjusts the light emission timing of the light beam emitted from the laser diode LD, using the beam pitch shift amount calculated as above. The storage device 92 stores therein a dot pattern to be subsequently described.

Hereunder, the light emission timing of the laser diode LD will be described. As shown in FIG. 3, the light source unit 401 can be made to rotate about the axial line L passing the center of the front end face 61, as indicated by the arrow C, so that the laser diode LD, linearly aligned at regular intervals, can be set to a predetermined angle with respect to the main scanning direction. In general, the pitch between beam spots of the laser diode LD (position on the scanned surface of the photoconductor drum 31, where the light beam from the laser diode LD forms the image) in the sub scanning direction is adjusted by rotating the laser diode LD, and the pitch between the beam spots in the main scanning direction is adjusted by the light emission timing of the laser diode LD.

On the production line of the optical scanning device 40, the pitch between the beam spots in the main scanning direction is measured, and the measured value is stored in the memory 41 provided in the optical scanning device 40. When performing the image forming operation, the controller 91 retrieves the measured value from the memory 41 of the optical scanning device 40, and adjusts the light emission timing.

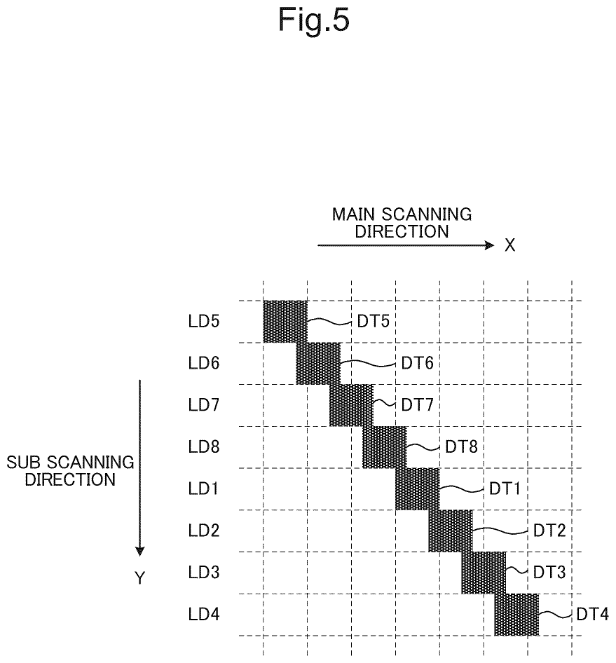

FIG. 5 illustrates starting positions of dots DT1 to DT8, formed on the photoconductor drum 31 when all the laser diodes LD are simultaneously turned on, so that the light beams are simultaneously emitted from each of the laser diodes LD. The light beams emitted from the respective laser diodes LD draw an electrostatic latent image on the scanned surface of the photoconductor drum 31, because of the rotation of the polygon mirror 404, such that the starting positions are obliquely inclined with respect to the sub scanning direction.

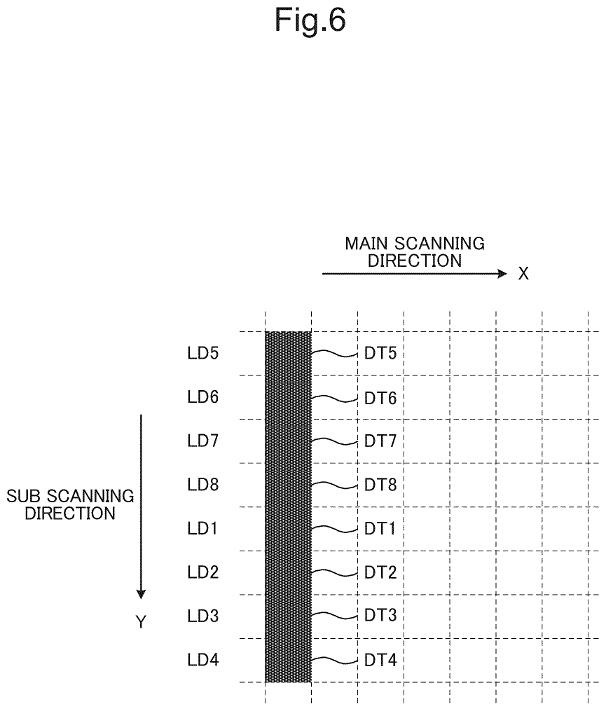

To make the starting positions of the electrostatic latent image in the main scanning direction accord with each other, the controller 91 adjusts the light emission timing of the laser diode LD. For example, to make the starting positions in the main scanning direction accord with each other, the controller 91 sets the order of light emission from the laser diode LD, as LD4, LD3, LD2, LD1, LD8, LD7, LD6, and LD5, so that the drawing starts from the dot farthest on the downstream side in the main scanning direction, among the dots DT1 to DT8. FIG. 6 illustrates the starting positions of the dots DT1 to DT8, formed on the photoconductor drum 31 when the light emission timing is adjusted by setting the order of light emission as LD4, LD3, LD2, LD1, LD8, LD7, LD6, and LD5.

In the light source unit 401, the position of the light emitting point of the laser diode LD is quite accurately determined during the manufacturing process. Actually, however, the measured value stored in the memory 41 of the optical scanning device 40, and the pitch between the beam spots on the photoconductor drum 31 of the image forming apparatus 1, may discord from each other. This is because of, for example, nonuniformity in the assembly work of the image forming device 12 in the image forming apparatus 1, a positional shift of the optical scanning device 40 installed in the main body of the image forming apparatus 1, and a processing allowance of the optical parts located between the light source unit 401 and the photoconductor drum 31. The shift of the beam spot (dot shift) arising from the mentioned reasons may lead to degradation in picture quality.

Examples of detection methods of the shift amount of the pitch between the beam spots include forming toner images of a predetermined plurality of image patterns (detection pattern), calculating the density difference among the toner images, and measuring the pitch between the beam spots of the light source unit 401 in the main scanning direction, utilizing the correlation between the density difference and the shift amount of the pitch between the beam spots. Hereinafter, the shift amount of the pitch between the beam spots will be expressed as “beam pitch shift amount”, and the measurement method thereof will be described.

### Measurement Method of Beam Pitch Shift Amount

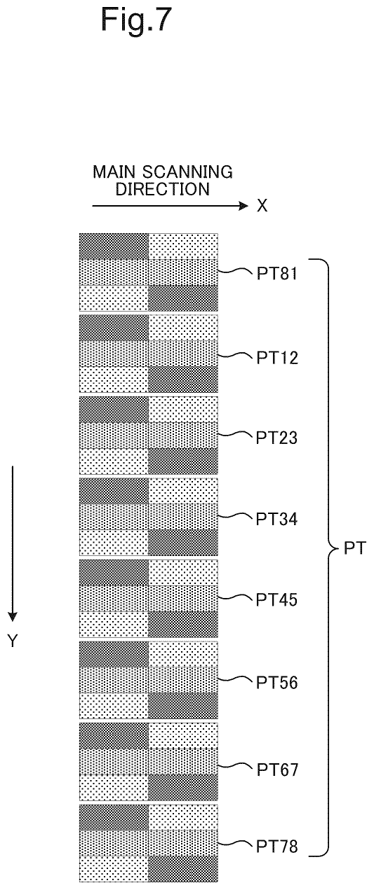

FIG. 7 is a schematic diagram showing an example of the detection pattern printed on the sheet P. First, the state where the laser diode LD is free from the beam pitch shift will be described. The detection pattern PT shown in FIG. 7 is formed by the image forming units 3M, 3C, 3Y, and 3Bk, with respect to the respective colors. Then the density sensor 50 detects the density of each of the detection patterns PT, and the controller 91 calculates the beam pitch shift amount of the laser diode LD, on the basis of the detected density. The controller 91 adjusts the light emission timing of the laser diode LD (shift amount of the emission timing), using the beam pitch shift amount. Accordingly, the position of the beam spot in the main scanning direction can be adjusted, and the dot shift can be corrected.

The detection pattern PT81 is for detecting the beam pitch shift of the laser diode LD8 and the laser diode LD1 in the main scanning direction, and the detection pattern PT12 is for detecting the beam pitch shift of the laser diode LD1 and the laser diode LD2 in the main scanning direction. The detection pattern PT23 is for detecting the beam pitch shift of the laser diode LD2 and the laser diode LD3 in the main scanning direction, and the detection pattern PT34 is for detecting the beam pitch shift of the laser diode LD3 and the laser diode LD4 in the main scanning direction.

The detection pattern PT45 is for detecting the beam pitch shift of the laser diode LD4 and the laser diode LD5 in the main scanning direction, and the detection pattern PT56 is for detecting the beam pitch shift of the laser diode LD5 and the laser diode LD6 in the main scanning direction. The detection pattern PT67 is for detecting the beam pitch shift of the laser diode LD6 and the laser diode LD7 in the main scanning direction, and the detection pattern PT78 is for detecting the beam pitch shift of the laser diode LD7 and the laser diode LD8 in the main scanning direction. Hereinafter, the detection patterns PT81, PT12, PT23, PT34, PT45, PT56, PT67, and PT78 will be collectively referred to as detection pattern PT.

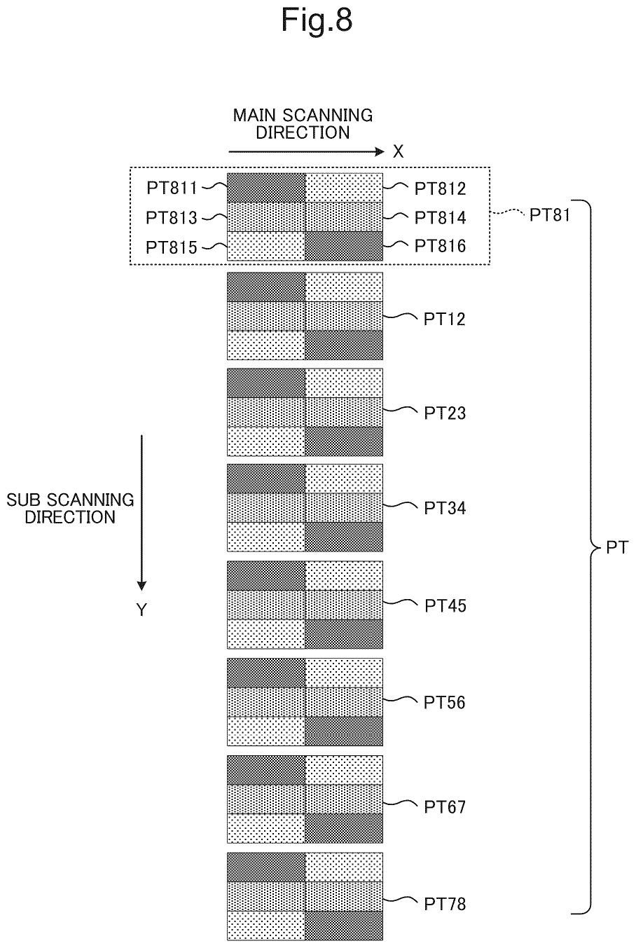

FIG. 8 is a schematic diagram for explaining the detection pattern PT in further detail. The description will be given with reference to the detection pattern PT81. The detection pattern PT81 includes detection patches PT811, PT812, PT813, PT814, PT815, and PT816, each formed, for example, in a rectangular shape. The detection patch PT812 is adjacent to the detection patch PT811 on the downstream side in the main scanning direction, the detection patch PT814 is adjacent to the detection patch PT813 on the downstream side in the main scanning direction, and the detection patch PT816 is adjacent to the detection patch PT815 on the downstream side in the main scanning direction.

The detection patches PT813 and PT814 are adjacent to the detection patches PT811 and PT812, respectively, on the downstream side in the sub scanning direction, and the detection patches PT815 and PT816 are adjacent to the detection patches PT813 and PT814, respectively, on the downstream side in the sub scanning direction.

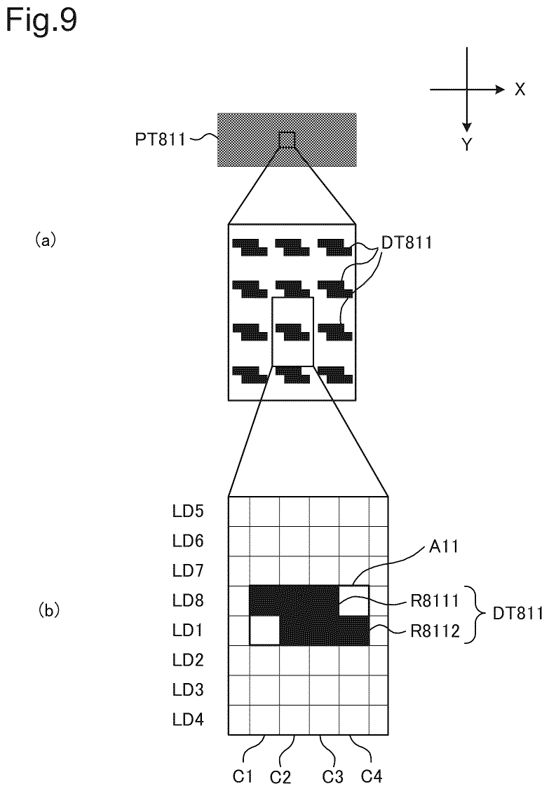

The detection patches PT811, PT812, PT813, PT814, PT815, and PT816 each include a plurality of dot patterns, which are different in each of the patches. FIG. 9 is a schematic diagram for explaining the detection patch PT811. The detection patch PT811 includes a plurality of dot patterns DT811, aligned in the main scanning direction and the sub scanning direction at predetermined intervals, as shown in a region (a) in FIG. 9.

An enlarged view of the dot pattern DT811 is shown in a region (b) in FIG. 9. The dot pattern DT811 includes a dot row R8111 and a dot row R8112, and the dot row R8111 is formed by the laser diode LD8, as a continuous line along the main scanning direction, having a length corresponding to 3 dots, from the position corresponding to the column C1. The dot row R8112 is formed by the laser diode LD1, as a continuous line along the main scanning direction, having a length corresponding to 3 dots, from the position corresponding to the column C2. The starting position of the dot row R8112 (column C2) is shifted from the starting position of the dot row R8111 (column C1) by an amount corresponding to 1 dot, to the downstream side in the main scanning direction.

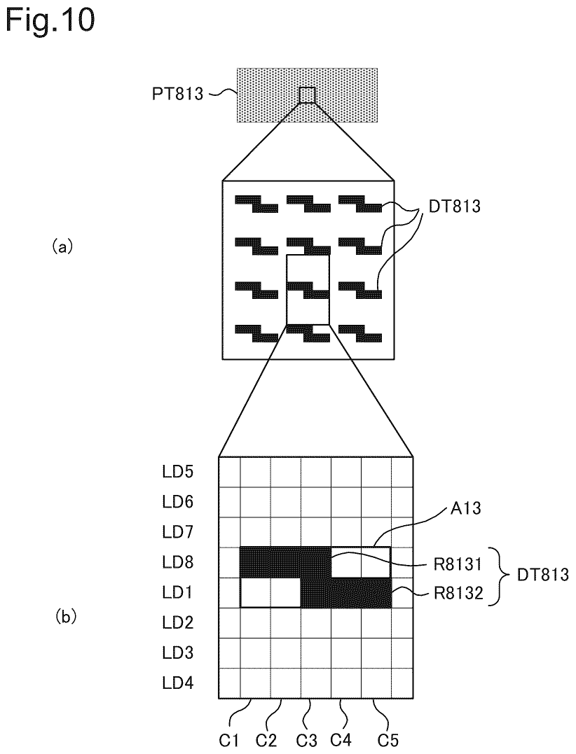

FIG. 10 is a schematic diagram for explaining the detection patch PT813. The detection patch PT813 includes a plurality of dot patterns DT813, aligned in the main scanning direction and the sub scanning direction at predetermined intervals, as shown in a region (a) in FIG. 10.

An enlarged view of the dot pattern DT813 is shown in a region (b) in FIG. 10. The dot pattern DT813 includes a dot row R8131 and a dot row R8132, and the dot row R8131 is formed by the laser diode LD8, as a continuous line along the main scanning direction, having a length corresponding to 3 dots, from the position corresponding to the column C1. The dot row R8132 is formed by the laser diode LD1, as a continuous line along the main scanning direction, having a length corresponding to 3 dots, from the position corresponding to the column C3.

The starting position of the dot row R8132 (column C3) is shifted from the starting position of the dot row R8131 (column C1) by an amount corresponding to 2 dots, to the downstream side in the main scanning direction. Further, although the starting position of the dot row R8111 and the dot row R8131 in the main scanning direction are the same (column C1), the starting position of the dot row R8132 (column C3) is shifted from the starting position of the dot row R8112 (column C2), by an amount corresponding to 1 dot, to the downstream side in the main scanning direction.

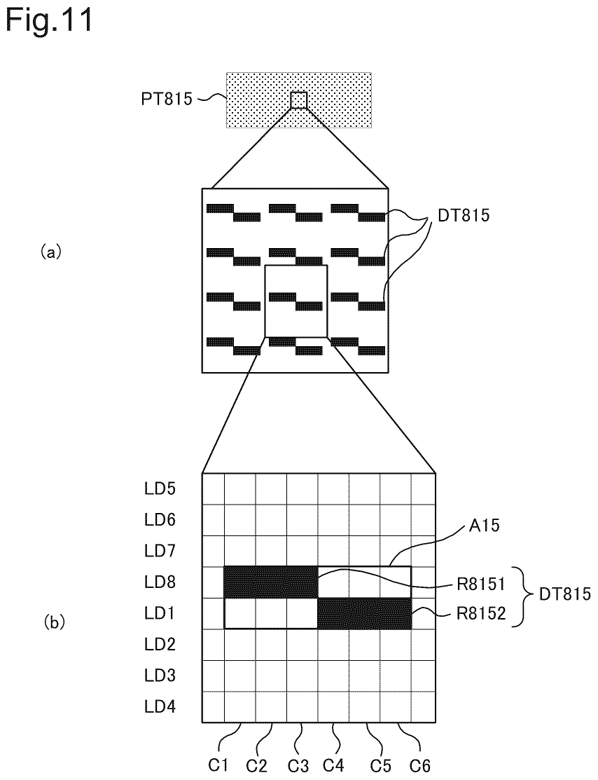

FIG. 11 is a schematic diagram for explaining the detection patch PT815. The detection patch PT815 includes a plurality of dot patterns DT815, aligned in the main scanning direction and the sub scanning direction at predetermined intervals, as shown in a region (a) in FIG. 11.

An enlarged view of the dot pattern DT815 is shown in a region (b) in FIG. 11. The dot pattern DT815 includes a dot row R8151 and a dot row R8152, and the dot row R8151 is formed by the laser diode LD8, as a continuous line along the main scanning direction, having a length corresponding to 3 dots, from the position corresponding to the column C1. The dot row R8152 is formed by the laser diode LD1, as a continuous line along the main scanning direction, having a length corresponding to 3 dots, from the position corresponding to the column C4.

The starting position of the dot row R8152 (column C4) is shifted from the starting position of the dot row R 8151 (column C1) by an amount corresponding to 3 dots, to the downstream side in the main scanning direction. Further, although the starting positions of the dot row R8111 and the dot row R8151 in the main scanning direction are the same (column C1), the starting position of the dot row R8152 (column C4) is shifted from the starting position of the dot row R8112 (column C2), by an amount corresponding to 2 dots, to the downstream side in the main scanning direction.

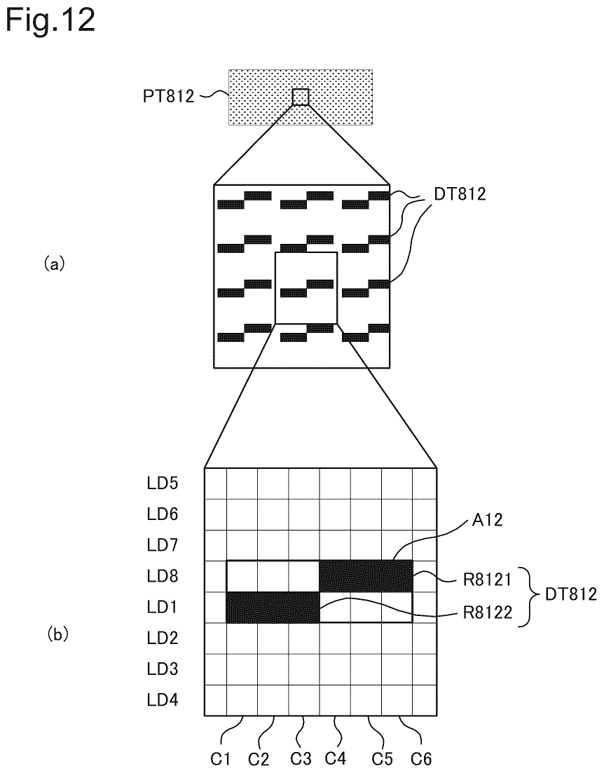

FIG. 12 is a schematic diagram for explaining the detection patch PT812. The detection patch PT812 includes a plurality of dot patterns DT812, aligned in the main scanning direction and the sub scanning direction at predetermined intervals, as shown in a region (a) in FIG. 12.

An enlarged view of the dot pattern DT812 is shown in a region (b) in FIG. 12. The dot pattern DT812 includes a dot row R8121 and a dot row R8122, and the dot row R8121 is formed by the laser diode LD8, as a continuous line along the main scanning direction, having a length corresponding to 3 dots, from the position corresponding to the column C4. The dot row R8122 is formed by the laser diode LD1, as a continuous line along the main scanning direction, having a length corresponding to 3 dots, from the position corresponding to the column C1. The starting position of the dot row R8121 (column C4) is shifted from the starting position of the dot row R8122 (column C1) by an amount corresponding to 3 dots, to the downstream side in the main scanning direction.

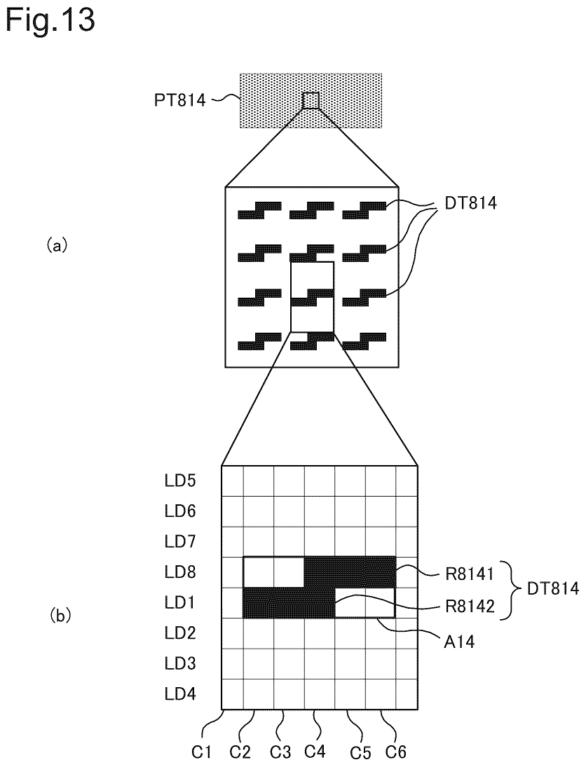

FIG. 13 is a schematic diagram for explaining the detection patch PT814. The detection patch PT814 includes a plurality of dot patterns DT814, aligned in the main scanning direction and the sub scanning direction at predetermined intervals, as shown in a region (a) in FIG. 13.

An enlarged view of the dot pattern DT814 is shown in a region (b) in FIG. 13. The dot pattern DT814 includes a dot row R8141 and a dot row R8142, and the dot row R8141 is formed by the laser diode LD8, as a continuous line along the main scanning direction, having a length corresponding to 3 dots, from the position corresponding to the column C4. The dot row R8142 is formed by the laser diode LD1, as a continuous line along the main scanning direction, having a length corresponding to 3 dots, from the position corresponding to the column C2. The starting position of the dot row R8141 (column C4) is shifted from the starting position of the dot row R8142 (column C2) by an amount corresponding to 2 dots, to the downstream side in the main scanning direction.

Further, although the starting positions of the dot row R8121 and the dot row R8141 in the main scanning direction are the same (column C4), the starting position of the dot row R8142 (column C2) is shifted from the starting position of the dot row R8122 (column C1), by an amount corresponding to 1 dot, to the downstream side in the main scanning direction.

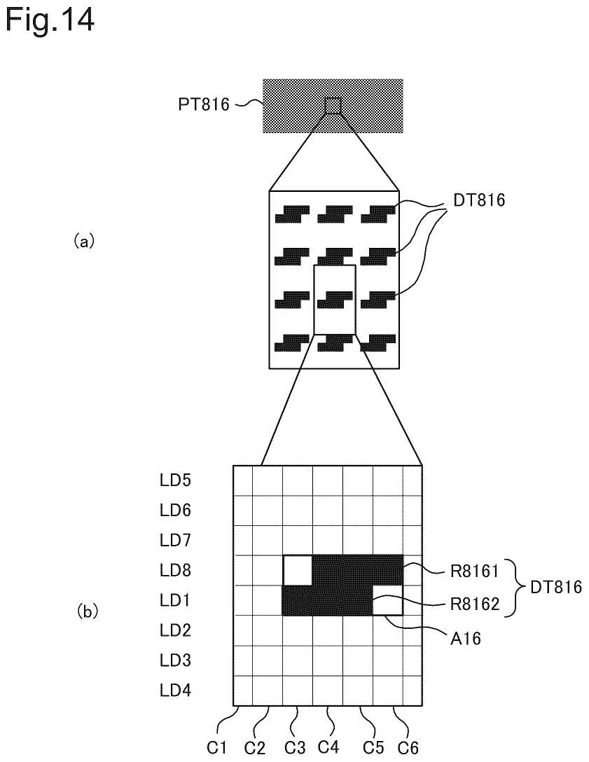

FIG. 14 is a schematic diagram for explaining the detection patch PT816. The detection patch PT816 includes a plurality of dot patterns DT816, aligned in the main scanning direction and the sub scanning direction at predetermined intervals, as shown in a region (a) in FIG. 14.

An enlarged view of the dot pattern DT816 is shown in a region (b) in FIG. 14. The dot pattern DT816 includes a dot row R8161 and a dot row R8162, and the dot row R8161 is formed by the laser diode LD8, as a continuous line along the main scanning direction, having a length corresponding to 3 dots, from the position corresponding to the column C4. The dot row R8162 is formed by the laser diode LD1, as a continuous line along the main scanning direction, having a length corresponding to 3 dots, from the position corresponding to the column C3. The starting position of the dot row R8161 (column C4) is shifted from the starting position of the dot row R8162 (column C3) by an amount corresponding to 1 dot, to the downstream side in the main scanning direction.

Further, although the starting positions of the dot row R8121 and the dot row R8161 in the main scanning direction are the same (column C4), the starting position of the dot row R8162 (column C3) is shifted from the starting position of the dot row R8122 (column C1), by an amount corresponding to 2 dots, to the downstream side in the main scanning direction.

As is apparent from FIG. 9 to FIG. 14, the pair of the dot pattern DT811 and the dot pattern DT816, the pair of the dot pattern DT812 and the dot pattern DT815, and the pair of the dot pattern DT813 and the dot pattern DT814, are line-symmetric.

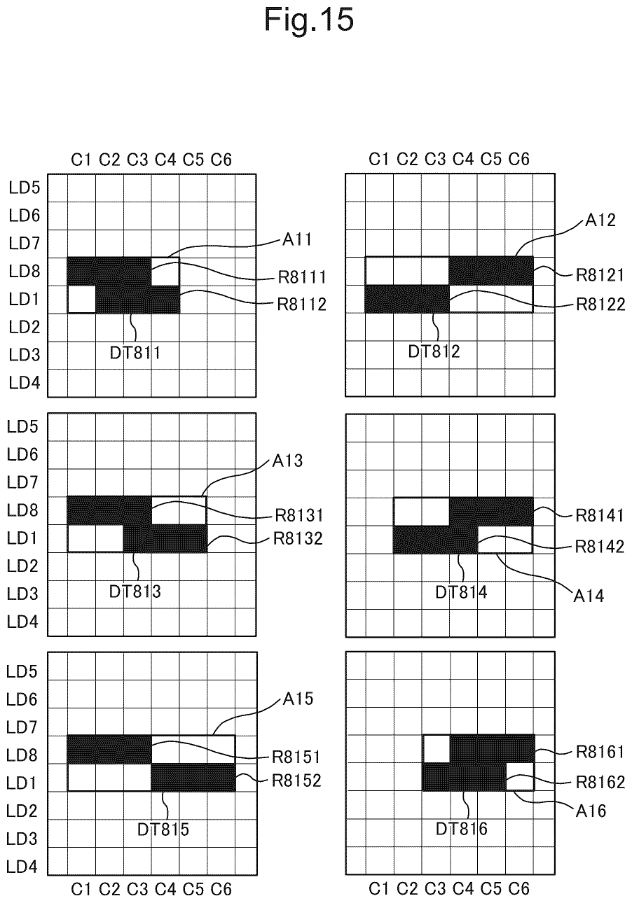

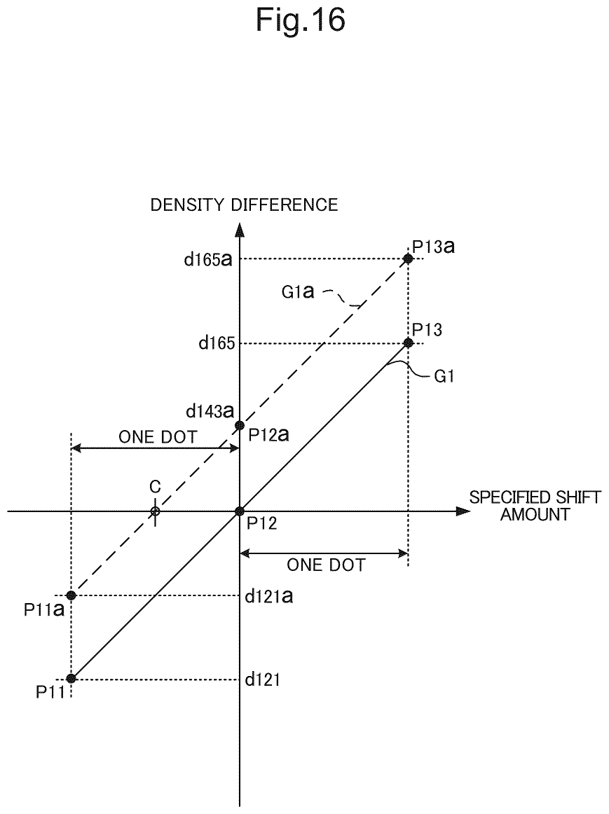

FIG. 15 is a schematic diagram collectively showing the dot patterns DT811 to DT816. FIG. 16 is a graph showing a relation between a specified shift amount and the density difference of the detection pattern. First, the density difference will be described. The density sensor 50 detects the density of each of the detection patches, included in the detection pattern PT printed on the sheet P.

The density D1 of the detection patch PT811 corresponds to a ratio of the total area of the dots, in an area A11 which is a rectangular region including the dot row R8111 and the R8112. The area A11 is a rectangular region enclosed in a line overlapping with the upstream edge of the dot row R8111 in the main scanning direction, a line overlapping with the downstream edge of the dot row R8112 in the main scanning direction, a line overlapping with the upstream edge of the dot row R8111 in the sub scanning direction, and a line overlapping with the downstream edge of the dot row R8112 in the sub scanning direction.

Likewise, the density D2 of the detection patch PT812 corresponds to a ratio of the total area of the dots, in an area A12. The density D3 of the detection patch PT813 corresponds to a ratio of the total area of the dots, in an area A13. The density D4 of the detection patch PT814 corresponds to a ratio of the total area of the dots, in an area A14. The density D5of the detection patch PT815 corresponds to a ratio of the total area of the dots, in an area A15. The density D6 of the detection patch PT816 corresponds to a ratio of the total area of the dots, in an area A16.

The controller 91 calculates a density difference d121 between the density D1 of the detection patch PT811 and the density D2 of the detection patch PT812 (=D2−D1), on the upper side of the detection pattern PT81 (upstream side in the sub scanning direction), a density difference d143 between the density D3 of the detection patch PT813 and the density D4 of the detection patch PT814 (=D4−D3), in the middle portion of the detection pattern PT81, and a density difference d165 between the density D5of the detection patch PT815 and the density D6 of the detection patch PT816 (=D6−D5), on the lower side of the detection pattern PT81 (downstream side in the sub scanning direction).

Here, since the dot pattern DT813 forming the detection patch PT813, and the dot pattern DT814 forming the detection patch PT814 are line-symmetric, the density is the same as each other (D4−D3=0).

The “specified shift amount” will be described hereunder. When the pattern of the middle portion is set as the reference, the dot row R8111 of the dot pattern DT811 of the detection patch PT811, and the dot row R8131 are located at the same position (starting from column C1). In contrast, the dot row R8112 is shifted by 1 dot to the upstream side in the main scanning direction, with respect to the dot row R8132. In addition, the dot row R8121 of the dot pattern DT812 of the detection patch PT812, and the dot row R8141 are located at the same position (starting from column C4). In contrast, the dot row R8122 is shifted by 1 dot to the upstream side in the main scanning direction, with respect to the dot row R8142. Such shift will be referred to as “specified shift”, and the corresponding shift amount will be referred to as “specified shift amount”.

Referring to the graph shown in FIG. 16, the point of the pattern of the upper side of the detection pattern PT81 is to be plotted. On the vertical axis, the density difference between the density D1 of the detection patch PT811 and the density D2 of the detection patch PT812 (D2−D1) falls on the point of d121, and on the horizontal axis, the specified shift amount corresponding to 1 dot to the upstream side in the main scanning direction falls on the point of 1 dot on the negative side. Thus, a point P11 is obtained.

Then the point of the pattern of the middle portion of the detection pattern PT81 is to be plotted. Since the density D3 of the detection patch PT813 and the density D4 of the detection patch PT814 are the same as each other, the density difference d143 (D4−D3) is 0. On the horizontal axis, since the detection patches PT813 and PT814 are set as the reference, the specified shift amount falls on 0. Therefore, a point P12 is plotted at the origin.

Then the point of the pattern of the lower side of the detection pattern PT81 is to be plotted. On the vertical axis, the density difference between the density D5of the detection patch PT815 and the density D6 of the detection patch PT816 (D6−D5) falls on the point of d165, and on the horizontal axis, the specified shift amount corresponding to 1 dot to the downstream side in the main scanning direction falls on the point of 1 dot on the positive side. Thus, a point P13 is obtained.

The detection patterns PT described with reference to FIG. 9 to FIG. 15 represent the case where the laser diode LD of the light source unit 401 is free from a beam pitch shift. In other words, a graph G1 drawn in solid line in FIG. 16 represents the relation between the specified shift amount and the density difference of the detection pattern PT81, of the case where the laser diodes LD1 and LD8 are free from the beam pitch shift, and the intersection point between the graph G1 and the horizontal axis indicates the beam pitch shift amount between the laser diodes LD1 and LD8.

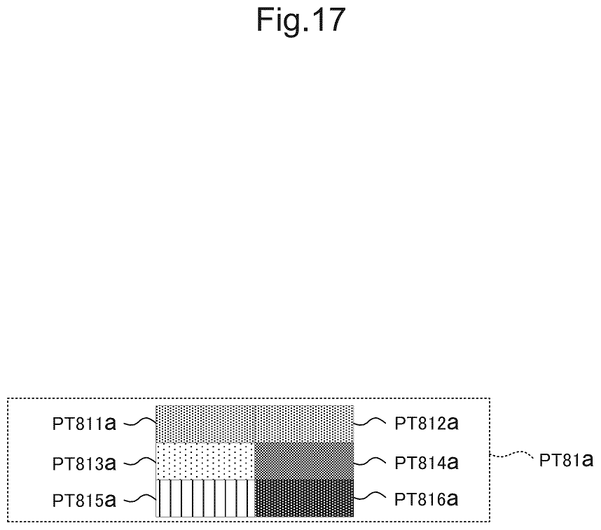

Hereunder, the case where the beam spot position of the laser diode LD1 is shifted to the downstream side in the main scanning direction, with respect to the beam spot position of the laser diode LD8, will be described. FIG. 17 is a schematic drawing showing an example of the detection pattern PT81a, drawn when the beam spot position of the laser diode LD1 is shifted to the downstream side in the main scanning direction, with respect to the beam spot position of the laser diode LD8.

Such a shift originates from, for example, a processing allowance in the manufacturing process of the optical parts, and therefore will be referred to as “beam pitch shift” and “beam pitch shift amount”, for distinction from the “specified shift” and “specified shift amount” described above.

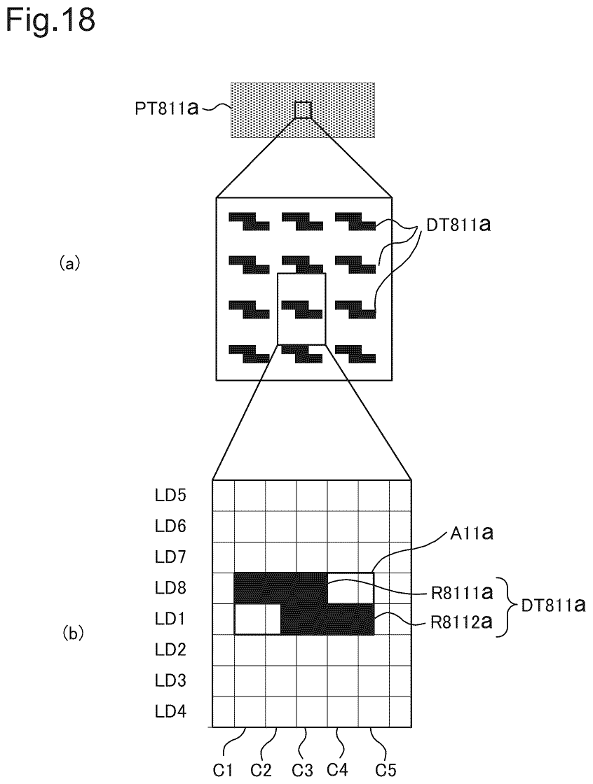

FIG. 18 is a schematic diagram for explaining a detection patch PT811a constituting a detection pattern PT81a. The detection patch PT811a is composed of dot patterns DT811a, and the dot pattern DT811a is composed of dot rows R8111a and R8112a. Since the beam spot position of the laser diode LD1 is shifted to the downstream side in the main scanning direction, the starting point of the dot row R8112a is shifted to the downstream side in the main scanning direction, with respect to the dot row R8112 shown in FIG. 9.

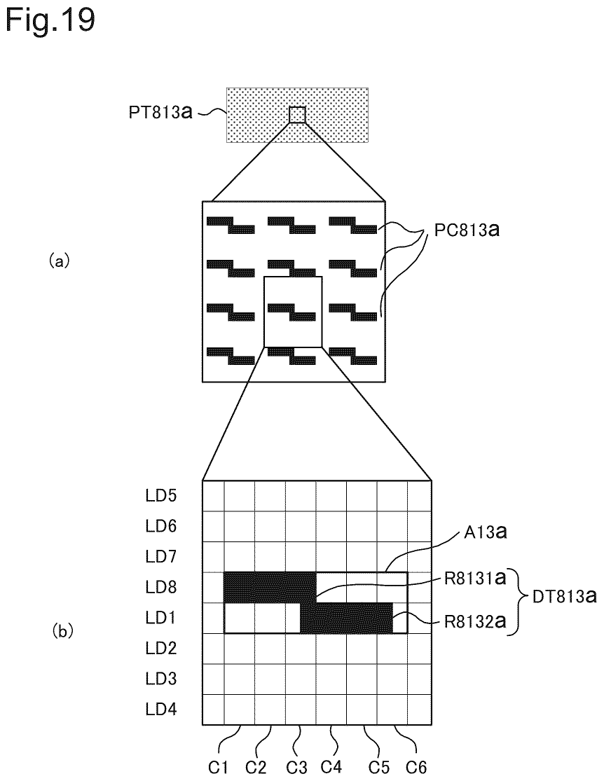

FIG. 19 is a schematic diagram for explaining a detection patch PT813a. The detection patch PT813a is composed of dot patterns DT813a, and the dot pattern DT813a is composed of dot rows R8131a and R8132a. The dot row R8132a is shifted to the downstream side in the main scanning direction, with respect to the dot row R8132 shown in FIG. 10.

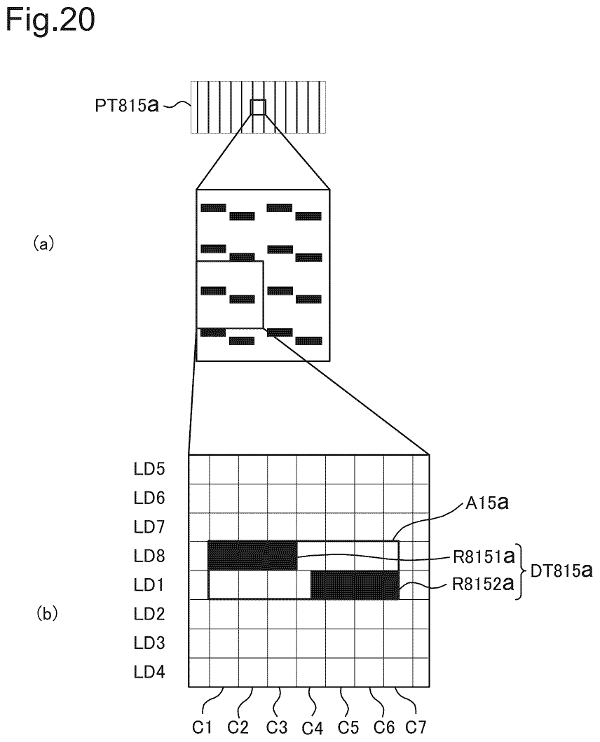

FIG. 20 is a schematic diagram for explaining a detection patch PT815a. The detection patch PT815a is composed of dot patterns DT815a, and the dot pattern DT815a is composed of dot rows R8151a and R8152a. The dot row R8152a is shifted to the downstream side in the main scanning direction, with respect to the dot row R8152 shown in FIG. 11.

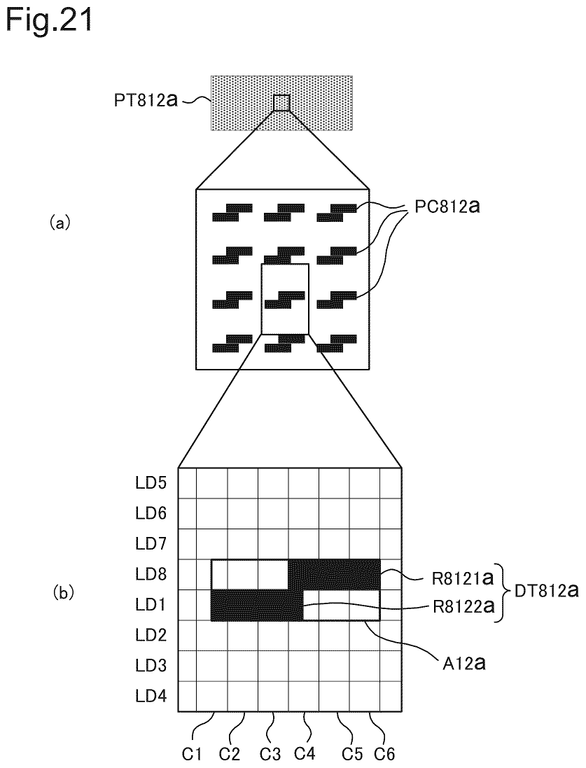

FIG. 21 is a schematic diagram for explaining a detection patch PT812a. The detection patch PT812a is composed of dot patterns DT812a, and the dot pattern DT812a is composed of dot rows R8121a and R8122a. The dot row R8122a is shifted to the downstream side in the main scanning direction, with respect to the dot row R8122 shown in FIG. 12.

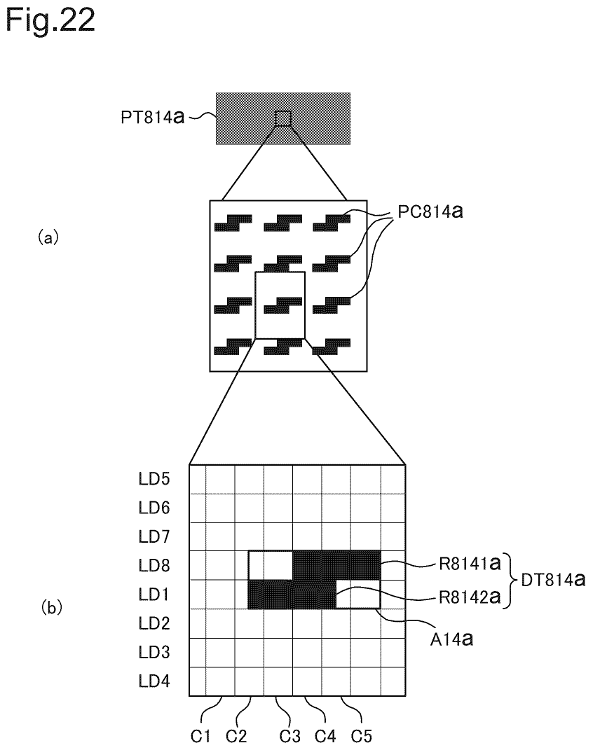

FIG. 22 is a schematic diagram for explaining a detection patch PT814a. The detection patch PT814a is composed of dot patterns DT814a, and the dot pattern DT814a is composed of dot rows R8141a and R8142a. The dot row R8142a is shifted to the downstream side in the main scanning direction, with respect to the dot row R8142 shown in FIG. 13.

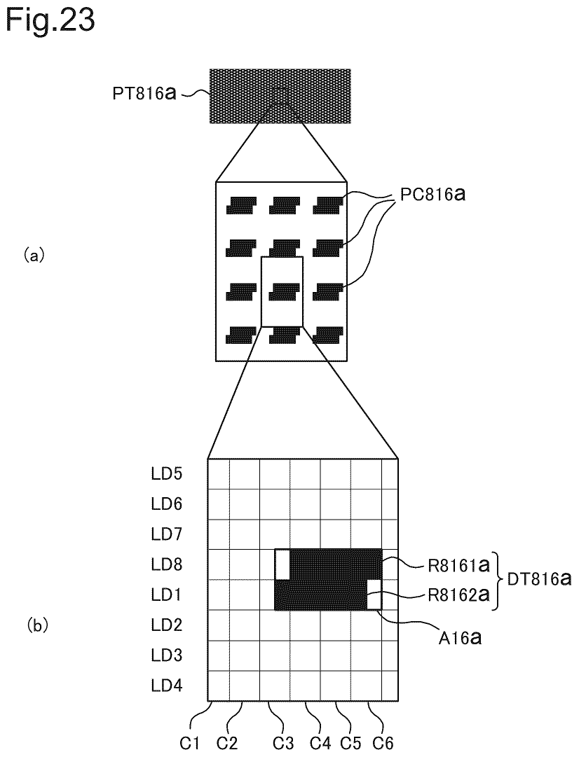

FIG. 23 is a schematic diagram for explaining a detection patch PT816a. The detection patch PT816a is composed of dot patterns DT816a, and the dot pattern DT816a is composed of dot rows R8161a and R8162a. The dot row R8162a is shifted to the downstream side in the main scanning direction, with respect to the dot row R8162 shown in FIG. 14.

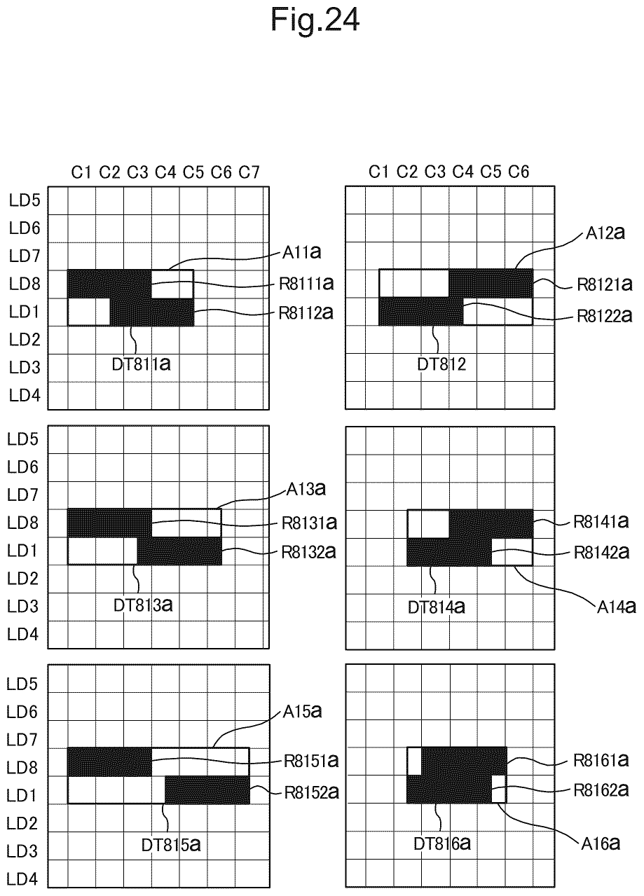

FIG. 24 is a schematic diagram collectively showing the dot patterns DT811a to DT816a. The density D1a of the detection patch PT811a corresponds, as shown in FIG. 24, to the ratio of the total area of the dots, in an area A11a which is a rectangular region including the dot rows R8111a and the R8112a.

Likewise, the density D2a of the detection patch PT812a corresponds to the ratio of the total area of the dots, in an area A12a. The density D3a of the detection patch PT813a corresponds to the ratio of the total area of the dots, in an area A13a. The density D4a of the detection patch PT814a corresponds to the ratio of the total area of the dots, in an area A14a. The density D5a of the detection patch PT815a corresponds to the ratio of the total area of the dots, in an area A15a. The density D6a of the detection patch PT816a corresponds to the ratio of the total area of the dots, in an area A16a.

The controller 91 calculates a density difference d121a between the density D1a of the detection patch PT811a and the density D2a of the detection patch PT812a (=D2a D1a), on the upper side of the detection pattern PT81a, a density difference d143a between the density D3a of the detection patch PT813a and the density D4a of the detection patch PT814a (=D4a−D3a), in the middle portion of the detection pattern PT81a, and a density difference d165a between the density D5a of the detection patch PT815a and the density D6a of the detection patch PT816a (=D6a−D5a), on the lower side of the detection pattern PT81a.

The point of the pattern of the upper side of the detection pattern PT81a is to be plotted on the graph of FIG. 16. The density difference falls on the point of d121a on the vertical axis, and on the horizontal axis, the specified shift amount corresponding to 1 dot to the upstream side in the main scanning direction falls on the point of 1 dot on the negative side. Thus, a point P11a is obtained.

Then the point of the pattern of the middle portion of the detection pattern PT81a is to be plotted. The density difference falls on the point of d143a on the vertical axis, and the specified shift amount falls on 0 on the horizontal axis. Therefore, a point P12a is obtained.

Then the point of the pattern of the lower side of the detection pattern PT81a is to be plotted. On the vertical axis, the density difference between the density D5a of the detection patch PT815a and the density D6a of the detection patch PT816a (D6a−D5a) falls on the point of d165a, and on the horizontal axis, the specified shift amount corresponding to 1 dot to the downstream side in the main scanning direction falls on the point of 1 dot on the positive side. Thus, a point P13a is obtained.

The detection pattern PT81a described with reference to FIG. 17 to FIG. 24 represents the case where the laser diode LD1 of the light source unit 401 is suffering a beam pitch shift, with respect to the laser diode LD8. In other words, a graph G1a drawn in broken line in FIG. 16 represents the relation between the specified shift amount and the density difference of the detection pattern PT81a, of the case where the beam pitch shift has arisen between the laser diodes LD1 and LD8, and the intersection point C between the graph G1a and the horizontal axis indicates the beam pitch shift amount between the laser diodes LD1 and LD8.

The value of the intersection point C on the horizontal axis is approximately a half of 1 dot, which is the specified shift amount. In other words, density sensor 50 detects the density of the detection patches constituting the detection pattern PT, the controller 91 calculates the density difference, thereby calculating the relation between the specified shift amount and the density difference shown in FIG. 16, and further calculates the coordinate of the intersection point C on the horizontal axis. Then the controller 91 can adjust the light emission timing of the laser diodes LD of the light source unit 401, on the basis of the beam pitch shift amount, thereby correcting the beam pitch shift amount and cancelling the dot shift. Consequently, degradation in picture quality can be prevented.

### Detection Error Range of Beam Pitch Shift Amount

However, when the density of the detection pattern PT81 becomes uneven, owing to the imaging process or status of the light source unit 401 of the optical scanning device 40, the beam pitch shift amount is unable to be accurately detected, with the mentioned method. In the case where the density of the detection pattern PT81 is uneven, and therefore the beam pitch shift amount has not been accurately detected, the controller 91 is led to adjust the light emission timing of the laser diodes LD on the basis of an erroneous shift amount, which may lead to degradation in picture quality due to the dot shift.

The range of the detection error of the beam pitch shift amount, arising from the uneven density of the detection pattern PT81, is related with the detection sensitivity with respect to the beam pitch shift of the laser diodes LD, and the higher the detection sensitivity is, the smaller the detection error range becomes. This will be described in further detail hereunder.

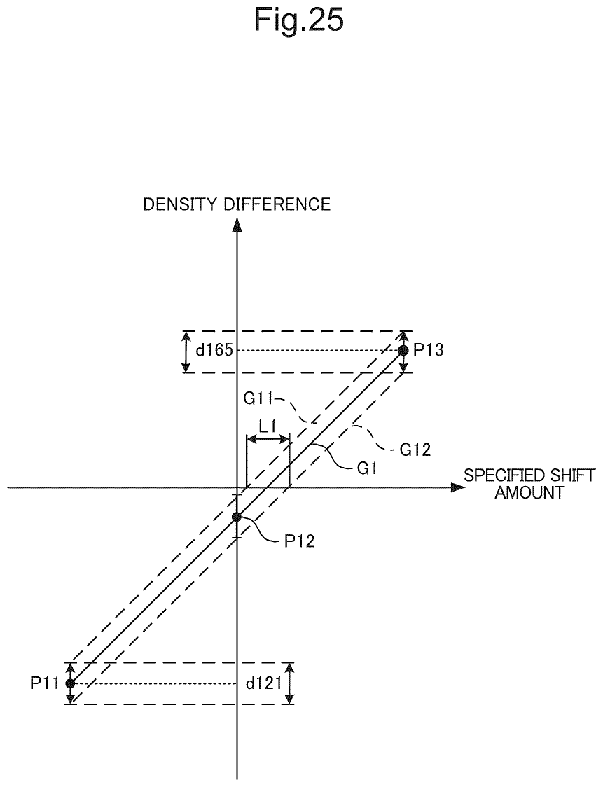

Referring to FIG. 25, it will be assumed that, when the density of the detection pattern PT81 becomes uneven, the density difference d121 between the density D1 of the detection patch PT811 and the density D2 of the detection patch PT812 (D2−D1) fluctuates by an amount indicated by an arrow. In this case, the point P11 also fluctuates by the amount indicated by the arrows. When it is assumed that the density difference d165 between the density D5of the detection patch PT815 and the density D6 of the detection patch PT816 (D6−D5) also fluctuates by an amount indicated by an arrow, the point P13 also fluctuates by the amount indicated by the arrows. Therefore, the graph G1 may fluctuate between a graph G11 and a graph G12 drawn in broken lines, and the beam pitch shift amount may assume a value between the intersection points with the graph G11 and the graph G12, on the horizontal axis (range indicated by an arrow L1). The range L1 corresponds to the detection error range of the beam pitch shift amount.

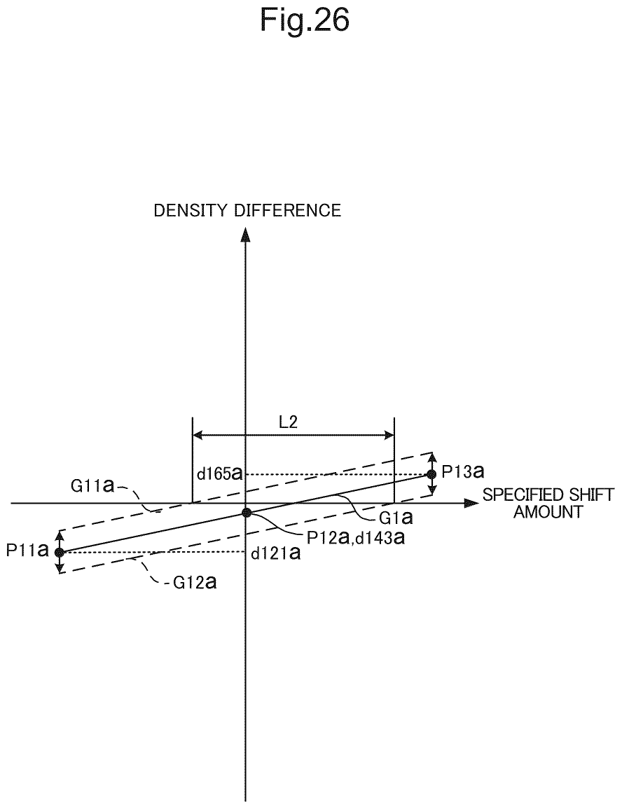

FIG. 26 is a graph representing the case where the density of the detection pattern PT81 is uneven, and the density difference of the detection patches constituting the detection pattern PT81 is small. Since the density difference of the detection patches constituting the detection pattern PT81 is small, when the density difference of the pattern on the upper side is d121a, the density difference of the pattern in the middle portion is d143a, and the density difference of the pattern on the lower side is d165a, the relation of the density difference with the detection pattern PT free from the beam pitch shift can be expressed as |d121|<|d121a|, and |d165|<|d165a|.

When the density difference d121a and the density difference d165a fluctuate in the range indicated by the arrows, the graph G1a may fluctuate in the range between the graph G11a and the graph G12a, and the beam pitch shift amount may assume a value between the intersection points with the graph G11a and the graph G12a, on the horizontal axis (range indicated by an arrow L2). Thus, the range L2 corresponds to the detection error range of the beam pitch shift amount. As shown in FIG. 25 and FIG. 26, when the density difference of the detection patch is large (graph is steeply inclined), the detection error range of the beam pitch shift amount is small (L1<L2). Therefore, the detection accuracy of the beam pitch shift amount can be improved, by reducing the detection error range of the beam pitch shift amount.

### Optimum Light Amount for Drawing Detection Pattern PT

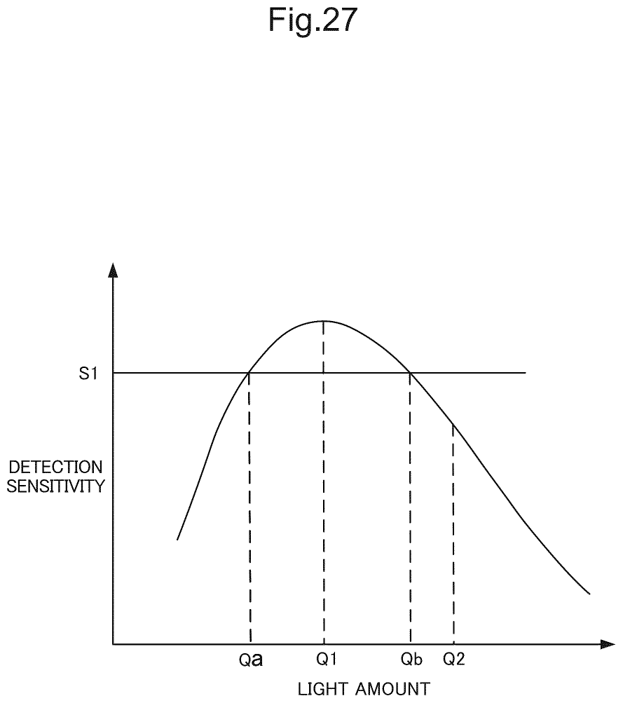

It has been proven through experiments, that the detection sensitivity (detection accuracy) of the beam pitch shift amount is correlated with the light amount of the light beam, emitted from the laser diode LD to draw the detection pattern. FIG. 27 is a graph showing a relation between the light amount of the light beam and the detection sensitivity of the beam pitch shift amount, when drawing the detection pattern. The detection sensitivity of the beam pitch shift amount becomes maximum with a light amount Q1, and when the light amount increases from Q1, the density of the detection pattern comes closer to saturation (density difference between the detection patches becomes smaller), and therefore the detection sensitivity gradually declines. In contrast, when the light amount decreases from Q1, the density of the detection pattern becomes pale (density difference between the detection patches becomes smaller), and therefore the detection sensitivity sharply drops.

The light amount Q2 is employed for the normal image forming operation. However, when the detection pattern is drawn with the light amount Q2, the detection sensitivity of the beam pitch shift amount becomes lower. Accordingly, when drawing the detection pattern, the controller 91 sets the light amount of the light beam to a value smaller than the light amount Q2, used for the normal image forming operation. By thus setting the light amount of the light beam to an optimum light amount that upgrades the detection sensitivity of the beam pitch shift amount, the detection accuracy of the beam

### Pitch Shift Amount can be Improved.

Therefore, when forming the normal electrostatic latent image for the normal image forming operation, the controller 91 sets the light amount of the light beam to a predetermined normal light amount (light amount Q2 in FIG. 27). In addition, the controller 91 sets the light amount of the light beam for drawing the detection pattern to a predetermined light amount for adjustment (between light amounts Qa and Qb in FIG. 27), smaller than the normal light amount (light amount Q2 in FIG. 27), and which provides the detection sensitivity (detection accuracy) of the beam pitch shift amount equal to or higher than a predetermined threshold (S1 in FIG. 27). Such normal light amount and the light amount for adjustment are, for example, stored in the storage device 92. The light amount for adjustment is detected in advance before the shipment of the image forming apparatus 1, through an experiment carried out by the manufacturer by actually operating the image forming apparatus 1, and stored in the storage device 92. The normal light amount is also stored in advance in the storage device 92, by the manufacturer. The controller 91 retrieves and uses the normal light amount from the storage device 92, for the normal image forming operation, and retrieves and uses the light amount for adjustment from the storage device 92, when drawing the detection pattern.

Here, although the beam pitch shift incurs periodical dot shift in the image, the vision of a human is unable to recognize a dot shift amount smaller than 10 μm. Accordingly, it is preferable to set the optimum light amount of the light beam for drawing the detection pattern such that the detection error range of the beam pitch shift amount (range L1 or range L2) falls within ±10 μm, to further reduce the detection error range of the beam pitch shift amount and upgrade the detection accuracy. Therefore, the light amount that falls within the range between the light amounts Qa and Qb in FIG. 27, and makes the detection error range of the beam pitch shift amount (range L1 or range L2) fall within ±10 μm, is detected in advance as the light amount for adjustment, before the shipment of the image forming apparatus 1, through the experiment carried out by the manufacturer by actually operating the image forming apparatus 1, and stored in the storage device 92.

In other words, the inclination of the graph indicating the relation between the density difference of the detection patch and the specified shift amount, described with reference to FIG. 16, FIG. 25, and FIG. 26, determines the light amount of the light beam that makes the detection error range of the beam pitch shift amount fall within ±10 μm, and such light amount is used when drawing the detection pattern PT. Thus, it is preferable that the difference between the value indicating the density difference between the detection patches constituting the detection pattern on the upper side, and the value indicating the density difference between the detection patches constituting the detection pattern on the lower side, is larger.

By setting thus the light amount of the light beam for drawing the detection pattern, the density of the detection pattern assumes an optimum value for calculating the beam pitch shift amount. In addition, although a dot shift arises owing to a detection error range of the beam pitch shift amount, the shift amount can be suppressed to a level that a human is unable to visually recognize.

According to this embodiment, the density sensor 50 detects the density of the detection pattern PT printed on the sheet P. However, instead of installing the density sensor 50, the user may set the sheet P having the detection pattern printed thereon on the image reading device 5, and the controller 91 may analyze the scanned image acquired by the image reading device 5, to thereby detect the density of the detection pattern PT. In this case, the image reading device 5 and the controller 91 correspond to the density detection device according to the disclosure.

### Second Embodiment

In the first embodiment, the optimum light amount of the light beam for drawing the detection pattern PT, which can reduce the detection error range of the beam pitch shift amount, has been described. In a second embodiment, a calculation method employed by the controller 91, to calculate the beam pitch shift amount using a half of the detection pattern PT shown in FIG. 7 and FIG. 8, will be described. FIG. 1 to FIG. 4, respectively showing the front cross-sectional view of the image forming apparatus 1, the perspective view of the optical scanning device 40 and the light source unit 401, and the electrical configuration of the image forming apparatus 1, referred to in the first embodiment, will also be referred to in the second embodiment, and the description of those drawings will not be repeated.

The first embodiment represents the case where, as shown in FIG. 7 and FIG. 8, eight detection patterns are formed, namely the detection pattern PT81 drawn by the laser diodes LD8 and LD1, the detection pattern PT12 drawn by the laser diodes LD1 and LD2, the detection pattern PT23 drawn by the laser diodes LD2 and LD3, the detection pattern PT34 drawn by the laser diodes LD3 and LD4, the detection pattern PT45 drawn by the laser diodes LD4 and LD5, the detection pattern PT56 drawn by the laser diodes LD5 and LD6, the detection pattern PT67 drawn by the laser diodes LD6 and LD7, and the detection pattern PT78 drawn by the laser diodes LD7 and LD8.

Thus, the detection patterns are formed on the basis of seven sets of combinations of the laser diodes adjacent to each other (laser diodes LD8 and LD1, LD1 and LD2, LD2 and LD3, LD3 and LD4, LD5 and LD6, LD6 and LD7, and LD7 and LD8), and the laser diodes LD4 and LD5 at the respective ends, and the density of each of the eight detection patterns is measured, to calculate the beam pitch shift amount, under the control of the controller 91. Further, when the image forming apparatus 1 is a color printer, the detection patterns PT of four colors (magenta, cyan, yellow, and black), and the density of each of such detection patterns is measured, to calculate the beam pitch shift amount.

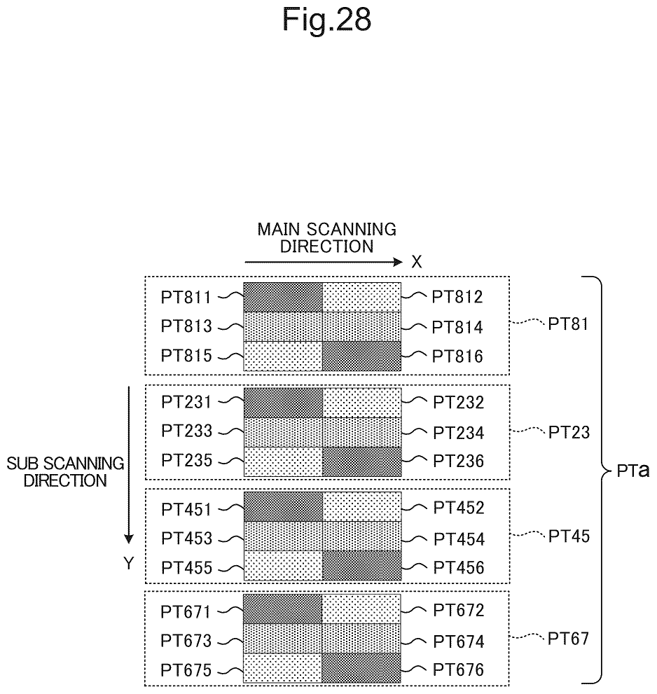

In this embodiment, four detection patterns PTa are formed, namely the detection pattern PT81 drawn by the laser diodes LD8 and LD1, the detection pattern PT23 drawn by the laser diodes LD2 and LD3, the detection pattern PT45 drawn by the laser diodes LD4 and LD5, and the detection pattern PT67 drawn by the laser diodes LD6 and LD7, as shown in FIG. 28, and the beam pitch shift amount is calculated with respect to each of the detection patterns, with the method described in the first embodiment, under the control of the controller 91. Further, with respect to the combinations of the laser diodes that are not used to draw the detection pattern, namely the laser diodes LD5 and LD6, laser diodes LD7 and LD8, laser diodes LD1 and LD2, and laser diodes LD3 and LD4, the beam pitch shift amount is calculated on the basis of the beam pitch shift amount calculated as above. Such calculation method will be described hereunder.

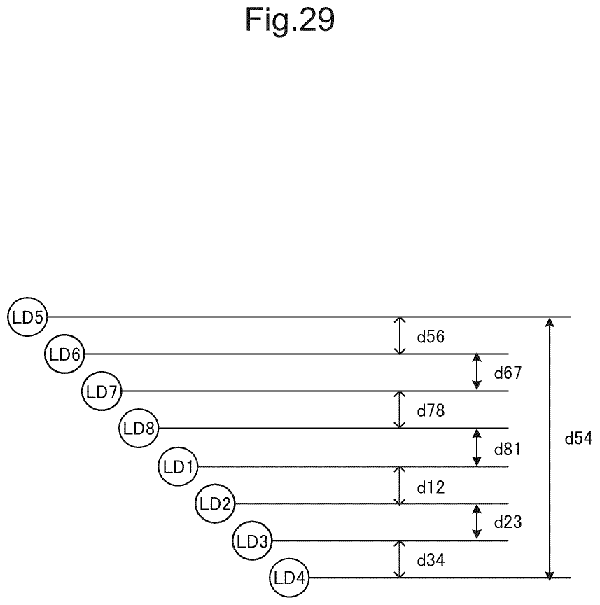

FIG. 29 is a schematic diagram for explaining the beam pitch of the light beam emitted from the laser diode LD, in a simplified manner. Actually, the controller 91 calculates the beam pitch shift amount of the light beam scanning on the photoconductor drum 31, but the path of the light beam from the laser diode LD to the photoconductor drum 31 is not shown in FIG. 29.

From the density of the detection pattern PTa shown in FIG. 28, a shift amount L67 of a beam pitch d67 between the laser diodes LD6 and LD7, a shift amount L81 of a beam pitch d81 between the laser diodes LD8 and LD1, a shift amount L23 of a beam pitch d23 between the laser diodes LD2 and LD3, and a shift amount L54 of a beam pitch d54 between the laser diodes LD5 and LD4, can be obtained.

The order of the numerals following “shift amount L” indicates, for example in the case of the shift amount L54, how the light emission timing of the laser diode LD4 is shifted, with reference to the laser diode LD5. To be more specific, when the shift amount L54 is positive, the light emission timing of the laser diode LD4 is delayed from the laser diode LD5, and when the shift amount L54 is negative, the light emission timing of the laser diode LD4 is earlier than the laser diode LD5.

A shift amount L56 of a beam pitch d56 between the laser diodes LD5 and LD6, a shift amount L78 of a beam pitch d78 between the laser diodes LD7 and LD8, a shift amount L12 of a beam pitch d12 between the laser diodes LD1 and LD2, and a shift amount L34 of a beam pitch d34 between the laser diodes LD3 and LD4, which are based on the combinations not used to draw the detection pattern PTa, is calculated by the controller 91 as described hereunder.

The beam pitch d54 between the laser diodes LD5 and LD4, located at the respective ends of the light source unit 401, corresponds to the total of the beam pitches d56, d67, d78, d81, d12, d23, and d34, as shown in FIG. 29. Accordingly, the beam pitch shift amount L54 of the laser diodes LD5 and LD4 assumes a value approximate to the total of the beam pitch shift amounts L56, L67, L78, L81, L12, L23, and L34.

Accordingly, the value obtained by subtracting the total of the beam pitch shift amounts L67, L81, and L23, calculated on the basis of the detection pattern PTa, from the beam pitch shift amount L54, corresponds to the total of the beam pitch shift amounts based on the combinations not used for drawing the detection pattern, namely the total of the beam pitch shift amounts L56, L78, L12, and L34, which can be expressed as an equation (1) as follows.

$$L 54 - ( L 67 + L 81 + L 23 ) = L 56 + L 78 + L 12 + L 34 \qquad ( 1 )$$

The beam pitch shift arises from, for example, nonuniformity in the assembly work of the image forming device 12 of the image forming apparatus 1, a positional shift of the optical scanning device 40 installed in the main body of the image forming apparatus 1, and a processing allowance of the optical parts located between the light source unit 401 and the photoconductor drum 31, each of which incurs a certain shift, with respect to the pitch between the laser diodes LD adjacent to each other. For example, the magnitude relation among the beam pitch shift amounts tends to be L34<L54<L56<L67, and is barely likely to be L34<L54>L56<L67. Therefore, the controller 91 calculates predicted values of the beam pitch shift amounts L56, L78, L12, and L34, using the following equation (2).

$$L 56 = L 78 = L 12 = L 34 = \{ L 54 - ( L 67 + L 81 + L 23 ) \} / 4 \qquad ( 2 )$$

The impact of a calculation error of the beam pitch shift amounts L67, L81, L23, and L54, based on the detection pattern PTa, is uniformly distributed among each of the beam pitch shift amounts L56, L78, L12, and L34. In other words, it is unlikely that the beam pitch shift amounts L56, L78, L12, and L34, obtained through the equation (2) largely differs from the actual beam pitch shift amount.

As described above, instead of drawing the detection pattern PT using all the combinations of the laser diodes LD adjacent to each other, to calculate the beam pitch shift amount, every other set of the laser diodes LD is extracted from all the sets of the laser diodes LD adjacent to each other, and the detection pattern PTa is drawn by the extracted sets of the laser diodes LD, to calculate the beam pitch shift amount. The beam pitch shift amount, based on the combinations of the laser diodes LD not used for drawing the detection pattern PTa, can be calculated using the beam pitch shift amount based on the combinations of the laser diodes LD that have drawn the detection pattern PTa.

The mentioned arrangement reduces the number of detection patterns to be drawn, and shortens the time required for calculating the beam pitch shift amount. In addition, the time for adjusting the optical scanning device 40 in the manufacturing process of the image forming apparatus 1 can be reduced, and resultantly the takt time of the image forming apparatus 1 can be shortened.

Here, the mentioned combinations of the laser diodes LD that draw the detection pattern PTa is only exemplary, and the detection pattern may be drawn with different combinations.

In general, when an electrophotographic printer forms an image, the light amount of the light beam emitted from the laser diode influences the density of the image. Accordingly, the image pattern used for measuring the beam pitch shift amount also has to be drawn with an appropriate light amount. When the density of the image pattern becomes uneven, the beam pitch shift amount suffers an error, and an accurate shift amount is unable to be obtained. In contrast, the arrangement according to the foregoing embodiments enables the beam pitch shift amount of the laser diode to be accurately detected.

While the present disclosure has been described in detail with reference to the embodiments thereof, it would be apparent to those skilled in the art that various changes and modifications may be made therein within the scope defined by the appended claims.

What is claimed is;

1. An image forming apparatus comprising:
an image forming device including an optical scanning device that forms, using a light source having a plurality of light emitters, aligned at regular intervals at a predetermined angle with respect to a main scanning direction, and a polygon mirror that deflectively scans a light beam emitted from each of the light emitters, an electrostatic latent image on an image carrier with the light beam, and prints an image on a sheet, by transferring a toner image obtained by developing the electrostatic latent image, onto the sheet;
a density detection device that detects image density of the image printed on the sheet;
a storage device that stores therein a predetermined plurality of types of dot patterns, for calculating a beam pitch shift amount, which is a shift amount of a pitch between the light beams in the main scanning direction, and formed on the image carrier by the light beam emitted from an adjacent light emitter; and
a control device that includes a processor, and acts, when the processor executes a control program, as a controller that:
causes the image forming device to form detection patches, each including a plurality of the dot patterns of a same shape, arranged in the main scanning direction and a sub scanning direction at predetermined intervals, with respect to each of the dot patterns, and to print the detection patches on the sheet, acquires density of the detection patches, among which the dot pattern is different, from the density detection device, calculates the beam pitch shift amount using the density of each of the detection patches, and controls the optical scanning device to adjust light emission timing of the light beam emitted from the light emitter, using the beam pitch shift amount calculated; and
sets, when the image forming device forms the detection patch, a light amount of the light beam emitted from the light emitter to a predetermined light amount for adjustment, smaller than a predetermined normal light amount of the light beam, emitted to form a normal electrostatic latent image, and which secures detection accuracy of the beam pitch shift amount, equal to or higher than a predetermined threshold.

2. The image forming apparatus according to claim 1,
wherein the light amount for adjustment of the light beam, emitted from the light emitter to draw the detection patch, is set to a light amount that makes an error range of the beam pitch shift amount calculated by the controller fall within ±10 μm.

3. The image forming apparatus according to claim 1,
wherein the controller causes a part of combinations, out of all the combinations of two of the light emitters adjacent to each other, among the plurality of light emitters linearly aligned, and two of the light emitters located at respective ends of the light emitters linearly aligned, to form the detection patch, calculates the beam pitch shift amount of the light emitters in the part of the combinations, and the beam pitch shift amount of the light emitters located at the respective ends, using the density of the detection patch, and calculates the beam pitch shift amount of the light emitters in the combinations other than the part of the combinations, using the beam pitch shift amount of the light emitters in the part of the combinations, and the beam pitch shift amount of the light emitters located at the respective ends.

4. The image forming apparatus according to claim 3,
wherein the controller calculates a difference between the beam pitch shift amount of the light emitters located at the respective ends of the light emitters linearly aligned, and a total of the beam pitch shift amount of the light emitters in the part of the combinations, and calculates the beam pitch shift amount of the light emitters in the combinations other than the part of the combinations, by dividing the difference by a number of the combinations other than the part of the combinations.

5. The image forming apparatus according to claim 1,
wherein the density detection device detects density by analyzing a scanned image acquired by an image reading device from a detection pattern, instead of detecting the density of the detection pattern printed on the sheet.
